(19) United States
(12) Patent Application Publication
(10) Pub. No.: US 2015/0043041 A1
(43) Pub. Date: Feb. 12, 2015

(54) MOBILE TERMINAL, SYMBOL SHEET, ASSISTANCE TOOL, IMAGE PROCESSING PROGRAM, AND IMAGE PROCESSING METHOD

(71) Applicant: KING JIM CO., LTD., Tokyo (JP)

(72) Inventors: Erika Matsushita, Tokyo (JP); Makiko Mochizuki, Tokyo (JP); Takashi Tateishi, Tokyo (JP)

(21) Appl. No.: 14/388,147

(22) PCT Filed: Mar. 18, 2013
(86) PCT No.: PCT/JP2013/057665

§ 371 Date: Sep. 25, 2014

(30) Foreign Application Priority Data
Mar. 26, 2012 (JP) 2012-069858

(51) Int. Cl. H04N 1/62; H04N 1/387; H04N 1/195

(52) U.S. Cl. CPC H04N 1/626; H04N 1/19594; H04N 1/3872; H04N 2201/0452; H04N 2201/0436
USPC 358/453

(57) ABSTRACT

There is provided an imaging technology allowing easy acquisition/storing of image data drawn in an arbitrary area by a user, without the use of a dedicated document sheet, where a restriction is hardly imposed on a document sheet in terms of design. There are included a camera that images an imaging object to which a symbol sheet including a predetermined symbol is attached, a central processing unit that detects the predetermined symbol from an original image of the imaging object imaged by the camera, that recognizes a predetermined area calculated based on the predetermined symbol as an image acquisition area, and that extracts, and acquires as image data, an image in the image acquisition area, and image data storage unit that stores the image data.

### FIELD

The present invention is an effective technique which is applied to a technique of capturing a document using a camera function of a compact digital camera or a mobile phone.

### BACKGROUND

Compact digital cameras and digital cameras mounted on mobile phones and smartphones are beginning to be able to perform highly precise image capturing of several millions of pixels or more, and are more and more often used in imaging, in addition to landscapes, persons and the like, paper documents, memoranda, business cards and the like.

There is known an image processing system which is capable of reading a surface image of a paper medium photographed by a camera mounted on, for example, an iPhone (a registered trademark of Aiphone Co., Ltd., the use of which is permitted to Apple Inc.) of Apple Inc., which is a representative smartphone, of detecting a symbol code provided at a predetermined position of the paper medium, of acquiring extracted image data by extracting just the image data which is in a predetermined area calculated based on the symbol code, and of saving the extracted image data (Patent Literature 1).

### CITATION LIST

### Patent Literature

Patent Literature 1: Japanese Patent No. 4904426

### SUMMARY

According to Patent Literature 1 mentioned above, for example, image capturing means recognizes a symbol mark which is printed at a specific position of a document, and imports and stores the image in the area surrounded by the symbol mark. Therefore, what is freely drawn in the area surrounded by the symbol mark may be easily stored as image data, but to achieve this, a dedicated document sheet has to be used.

Furthermore, a dedicated document sheet has the symbol mark printed thereon, and the area where a user may draw so as to import an image is limited to the inside of the symbol mark. Also, since the symbol mark is printed, there is a restriction in terms of design.

The present invention has been made in view of the above, and has its object to provide an imaging technology allowing easy acquisition/storing of image data drawn in an arbitrary area by a user, without the use of a dedicated document sheet, where a restriction is hardly imposed on a document sheet in terms of design.

### Solution to Problem

The present invention adopts the following means to solve the problems described above.

The present invention is a mobile terminal including a camera that images an imaging object to which a symbol sheet including a predetermined symbol is attached, a central processing unit that detects the predetermined symbol from an original image of the imaging object imaged by the camera, that recognizes a predetermined area calculated based on the predetermined symbol as an image acquisition area, and that extracts, and acquires as image data, an image in the image acquisition area, and image data storage unit that stores the image data.

According to the present invention, the predetermined symbol is present not on the imaging object, but on the symbol sheet, and the predetermined area may be recognized as the image acquisition area by capturing the imaging object to which the symbol sheet as the predetermined symbol is attached. The image in the recognized image acquisition area may be stored as image data. Thus, acquisition/storing of image data drawn in an arbitrary area by the user may be easily performed without the use of a dedicated document sheet to which the symbol is attached in advance. Also, since the symbol does not have to be attached in advance to the imaging object itself, the design of the imaging object may be improved. In other words, according to the present invention, there may be provided an imaging technology according to which a restriction is hardly imposed on a document sheet in terms of design. With respect to the symbol sheet, the entire tape-like sheet may function as the predetermined symbol, or the sheet may be represented by the predetermined symbol, or the predetermined symbol may be attached to a transparent sheet base material. Additionally, the mobile terminal may be configured to further include transmission means that transmits image data to a storage device of a server connected to the mobile terminal over a network.

Here, the predetermined symbol may be formed from an optical pattern that is different from an optical pattern present within a predetermined area of the imaging object. The optical pattern present within a predetermined area is a line, a letter, a sign, a figure or the like that is attached by the user on the front surface (the surface on the capturing side) of the imaging object, for example. By forming the predetermined symbol by an optical pattern that is different from the optical pattern present within a predetermined area of the imaging object, the central processing unit may, at the time of capturing by the camera the imaging object to which the symbol sheet is attached, distinguish between the predetermined symbol and the optical pattern present within the predetermined area. The predetermined symbol may be configured by a line, a letter, a sign, or a figure, and its mode is not particularly restricted. Additionally, the calculated predetermined area is an area that is established based on the predetermined symbol, and the predetermined area of the imaging object is an arbitrary area to which an optical pattern, such as a letter, is attached by the user, and these two are to be distinguished from each other.

Also, the optical pattern on the front surface (the surface on the capturing side) of the symbol sheet may be made different from the optical pattern on the front surface of the imaging object so that the central processing unit may reliably identify the symbol sheet. Detection of the symbol sheet is thereby facilitated, and the predetermined symbol and the optical pattern present within a predetermined area of the imaging object may be distinguished from each other more easily.

Also, the color of the imaging object and the color of the symbol sheet may be made different and a user may instruct the central processing unit (perform setting) of the colors of the imaging object and the symbol sheet before capturing the imaging object so as to enable the central processing unit to detect each color and to recognize the image acquisition area. The present invention indicates an example of a mode of different optical patterns, but detection of the symbol sheet may be facilitated by changing the “color”.

Here, the present invention may be specified as a mobile terminal including a camera that images an imaging object to which a predetermined symbol is attached by a user, a central processing unit that detects the predetermined symbol from an original image of the imaging object imaged by the camera, that recognizes a predetermined area calculated based on the predetermined symbol as an image acquisition area, and that extracts, and acquires as image data, an image in the image acquisition area, and image data storage unit that stores the image data, wherein the predetermined symbol is an optical pattern that is not perceived by a human eye under normal visible light.

According to the present invention, by capturing the imaging object to which the predetermined symbol is attached, the predetermined area may be recognized as the image acquisition area, and the image in the recognized image acquisition area may be stored as image data. Thus, acquisition/storing of image data drawn in an arbitrary area by a user may be easily performed without the use of a dedicated document sheet to which the symbol is attached in advance. Also, since the symbol does not have to be attached in advance to the imaging object itself, and the predetermined symbol is formed from an optical pattern that is not perceived by a human eye under normal visible light, the design of the imaging object may be improved.

For example, the predetermined symbol may be an optical pattern that emits light that can be perceived by the camera when irradiated with light of a specific wavelength. As the optical pattern, an optical pattern that includes a fluorescent material that emits light when light of a specific wavelength is irradiated thereon is cited as an example. In this case, the mobile terminal according to the present invention is preferably used together with a light source that emits light of the specific wavelength. This light source may be embedded in the mobile terminal, or may be configured separately from the mobile terminal. Also, a filter that changes the wavelength of light may be attached to the mobile terminal of the present invention. For example, using a filter that cuts visible light allows more reliable recognition by the camera.

Here, the central processing unit may detect the predetermined symbol from the original image, and recognize an area, of the imaging object, surrounded by the predetermined symbol as the image acquisition area. What is freely drawn in the area surrounded by the predetermined symbol may thereby be easily stored as image data.

Furthermore, the predetermined symbol may be formed from a line image, and the central processing unit may recognize an area surrounded by the line image as the image acquisition area. The line image is one mode of the predetermined symbol. The line image may be a non-continuous line such as a dotted line.

Moreover, the predetermined symbol may be a locator formed from a dot or a specific figure, and when a plurality of the locators attached to the imaging object are detected, the central processing unit may recognize an area surrounded by a figure having the detected locators as vertices as the image acquisition area. The locator is also one mode of the predetermined symbol. The locator may be a figure, a sign, a letter, or the like.

Here, the present invention may be specified as the symbol sheet, in one mode of attaching the predetermined symbol to the imaging object. That is, the present invention is a symbol sheet to be used together with a mobile terminal including a camera that images an imaging object to which a predetermined symbol is attached, a central processing unit that detects the predetermined symbol from an original image of the imaging object imaged by the camera, that recognizes a predetermined area calculated based on the predetermined symbol as an image acquisition area, and that extracts, and acquires as image data, an image in the image acquisition area, and image data storage unit that stores the image data, wherein the symbol sheet is to be attached to the imaging object, and includes the predetermined symbol at least on a side of a surface to be imaged.

By attaching the symbol sheet to the imaging object, what is freely drawn in an area surrounded by the predetermined symbol may be easily stored as image data without the use of a dedicated document sheet. With respect to the symbol sheet, the entire tape-like sheet may function as the predetermined symbol, or the sheet may be represented by the predetermined symbol, or the predetermined symbol may be attached to a transparent sheet base material

Here, the present invention may be specified as an assistant tool for attaching the predetermined symbol, in one mode of attaching the predetermined symbol to the imaging object. That is, the present invention is an assistant tool to be used together with a mobile terminal including a camera that images an imaging object to which a predetermined symbol is attached, a central processing unit that detects the predetermined symbol from an original image of the imaging object imaged by the camera, that recognizes a predetermined area calculated based on the predetermined symbol as an image acquisition area, and that extracts, and acquires as image data, an image in the image acquisition area, and image data storage unit that stores the image data, wherein the assistant tool includes an ink for attaching the predetermined symbol to the imaging object, and wherein, when attached to the imaging object by a user, the ink becomes an optical pattern that is not perceived by a human under normal visible light.

The predetermined symbol may be attached to the imaging object by the assistant tool, and what is freely drawn in an area surrounded by the predetermined symbol may be easily stored as image data without the use of a dedicated document sheet.

The ink may include at least one of an inorganic fluorescent paint and an infrared reflective paint. As the inorganic fluorescent paint, an ink that includes a fluorescent paint that emits light when irradiated with light of a specific wavelength (ultraviolet light) is cited as an example. Also, as the infrared reflective paint, an ink that includes a paint that reflects light of a specific wavelength (infrared light) that is irradiated thereon is cited as an example. In these cases, the mobile terminal according to the present invention preferably further includes a light source that emits light of the specific wavelength. Also, a filter that changes the wavelength of light may be used together with the assistant tool.

Furthermore, the present invention may be specified as a program that is executable by the central processing unit described above. For example, the present invention is an image processing program that is executable by a mobile terminal including a central processing unit that, when an imaging object to which a symbol sheet including a predetermined symbol is attached is imaged by a camera, detects the predetermined symbol from an original image of the imaging object imaged by the camera, recognizes a predetermined area calculated based on the predetermined symbol as an image acquisition area, and extracts, and acquires as image data, an image in the image acquisition area, and image data storage unit that stores the image data, the image processing program causing the central processing unit to execute: when the imaging object is imaged by the camera in such a way that a position of the predetermined symbol is included, detecting the predetermined symbol from the original image, recognizing a predetermined area calculated based on the position of the detected predetermined symbol as an image acquisition area, and extracting, and acquiring as image data, image data in the image acquisition area, and storing the image data in the image data storage unit. Also, for example, the present invention is an image processing program that is executable by a mobile terminal including a central processing unit that, when an imaging object to which a predetermined symbol is attached by a user is imaged by a camera, detects the predetermined symbol from an original image of the imaging object imaged by the camera, that recognizes a predetermined area calculated based on the predetermined symbol as an image acquisition area, and that extracts, and acquires as image data, an image in the image acquisition area, and image data storage unit that stores the image data, the image processing program causing the central processing unit to execute: when the imaging object is imaged by the camera in such a way that a position of the predetermined symbol is included, detecting, from the original image, the predetermined symbol that is an optical pattern that is not perceived by a human eye under normal visible light, recognizing a predetermined area calculated based on the position of the detected predetermined symbol as an image acquisition area, and extracting, and acquiring as image data, image data in the image acquisition area, and storing the image data in the image data storage unit.

Moreover, the present invention may be specified as an image processing method that is executable by the mobile terminal described above. For example, the present invention is an image processing method that is executable by a mobile terminal including a central processing unit that, when an imaging object to which a symbol sheet including a predetermined symbol is attached is imaged by a camera, detects the predetermined symbol from an original image of the imaging object imaged by the camera, recognizes a predetermined area calculated based on the predetermined symbol as an image acquisition area, and extracts, and acquires as image data, an image in the image acquisition area, and image data storage unit that stores the image data, the image processing method causing the central processing unit to execute: when the imaging object is imaged by the camera in such a way that a position of the predetermined symbol is included, detecting the predetermined symbol from the original image, recognizing a predetermined area calculated based on the position of the detected predetermined symbol as an image acquisition area, and extracting, and acquiring as image data, image data in the image acquisition area, and storing the image data in the image data storage unit. Furthermore, for example, the present invention is an image processing method that is executable by a mobile terminal including a camera that images an imaging object to which a predetermined symbol is attached by a user, a central processing unit that detects the predetermined symbol from an original image of the imaging object imaged by the camera, that recognizes a predetermined area calculated based on the predetermined symbol as an image acquisition area, and that extracts, and acquires as image data, an image in the image acquisition area, and image data storage unit that stores the image data, the image processing method causing the central processing unit to execute: when the imaging object is imaged by the camera in such a way that a position of the predetermined symbol is included, detecting, from the original image, the predetermined symbol that is an optical pattern that is not perceived by a human eye under normal visible light, recognizing a predetermined area calculated based on the position of the detected predetermined symbol as an image acquisition area, and extracting, and acquiring as image data, image data in the image acquisition area, and storing the image data in the image data storage unit.

Moreover, the present invention may be specified as an image processing system including the mobile terminal described above, and a server that is connected to the mobile terminal over a network and that includes a storage device for storing image data. The image processing system may include at least one of the symbol sheet, the assistant tool, the light source, and the filter described above.

According to the present invention, there is provided an imaging technology allowing easy acquisition/storing of image data drawn in an arbitrary area by a user, without the use of a dedicated document sheet, where a restriction is hardly imposed on a document sheet in terms of design.

### BRIEF DESCRIPTION OF THE DRAWINGS

FIG. 1 illustrates a diagram describing an image processing system according to a first embodiment.

FIG. 2 illustrates a symbol tape according to the first embodiment.

FIG. 3 illustrates a diagram describing a use state of the symbol tape according to the first embodiment.

FIG. 4 illustrates a configuration diagram of a smartphone with a camera according to the first embodiment.

FIG. 5 illustrates an explanatory diagram of a case where the image processing system according to the first embodiment is used in a network.

FIG. 6 illustrates a flow of image processing that is executed by the image processing system according to the first embodiment.

FIG. 7 illustrates a diagram describing an image processing system according to a second embodiment.

FIG. 8 illustrates a flow of image processing that is executed by the image processing system according to the second embodiment.

FIG. 9 illustrates an example where four locators are attached to a memorandum sheet.

FIG. 10 illustrates a flow of image processing that is executed by the image processing system according to the second embodiment.

FIG. 11 illustrates a case where a locator having another shape is present within a specified image acquisition area.

FIG. 12 illustrates a case where a locator having another shape is present within the specified image acquisition area.

FIG. 13 illustrates a schematic configuration of a stamp according to another embodiment.

### DESCRIPTION OF EMBODIMENTS

Hereinafter, embodiments of the present invention will be described with reference to the drawings while citing, as an example, an image processing system including a smartphone (MP) as a mobile terminal, a symbol tape 1, and a writing tool 2 as an assistant tool. Additionally, the configurations of the following embodiments are merely examples, and the present invention is not to be limited to the configurations of the embodiments.

### First Embodiment

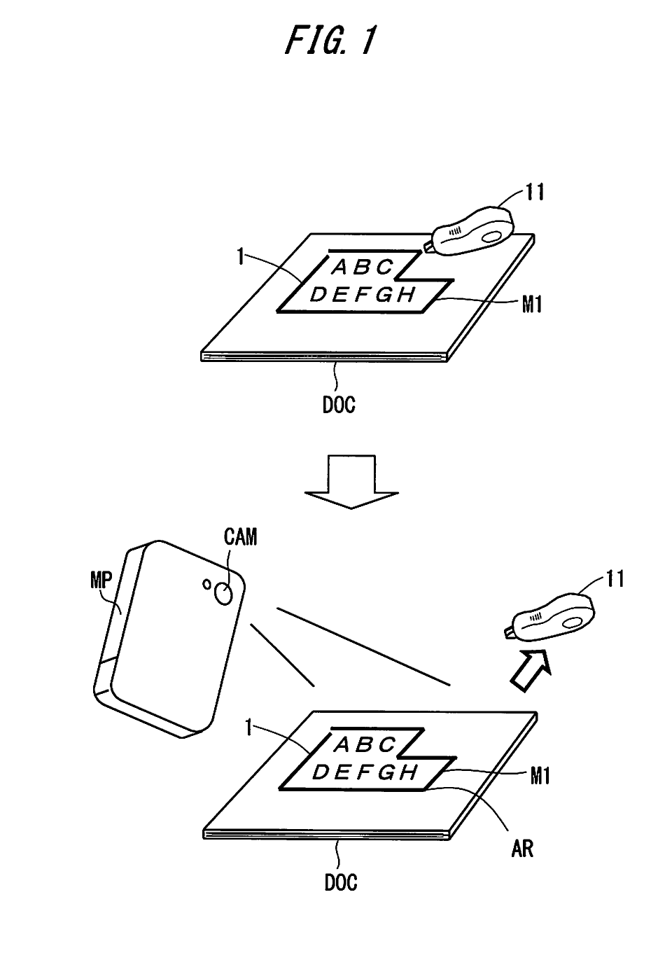

FIG. 1 illustrates a diagram describing an image processing system according to a first embodiment. The image processing system according to the first embodiment includes a smartphone with a camera (MP) as a mobile terminal, and a symbol tape 1 to be attached to a memorandum sheet (imaging object) (DOC).

<<Symbol Tape>>

The entire front surface of the symbol tape 1 is a symbol M1, and an adhesive layer is formed on the back surface of the symbol tape 1. The entire front surface of the symbol tape 1 is colored so as to be distinguished from the memorandum sheet (DOC). The color of the front surface of the symbol tape 1 may be any color as long as it can be distinguished from the base color of the memorandum sheet (DOC). The width of the symbol tape 1 is preferably such that it may be distinguished from lines forming the letters, signs, figures and the like described on the memorandum sheet (DOC). The width of the symbol tape 1 according to the first embodiment is designed to be thicker than the lines for forming the characters, signs, figures and the like which are expected to be drawn, but this is not restrictive. The adhesive force of the adhesive layer on the back surface is preferably such a strength that separation from the memorandum sheet (DOC) is allowed, but this is not restrictive.

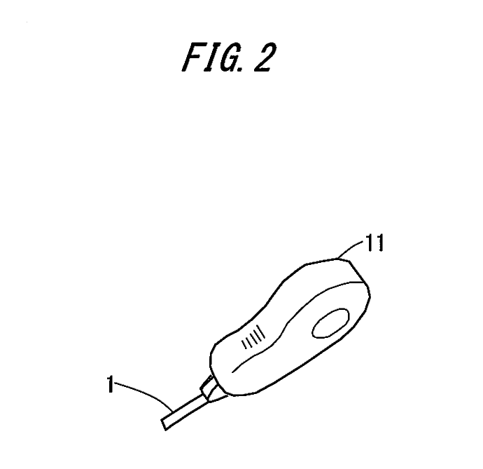

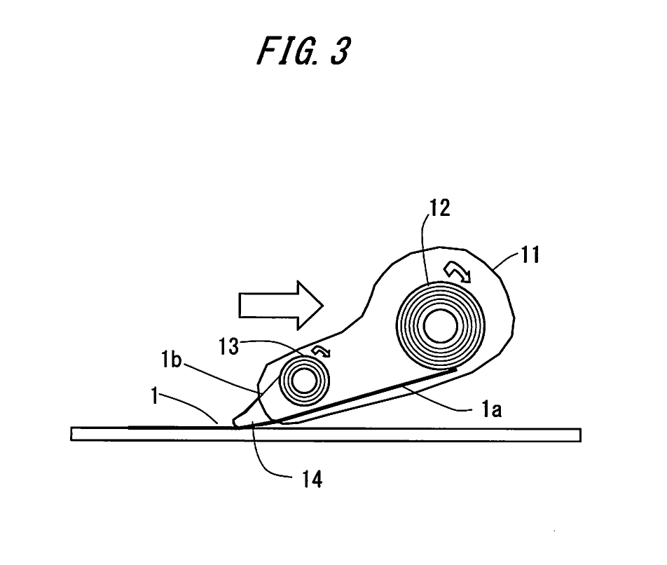

The symbol tape 1 according to the first embodiment is accommodated in a case 11, as illustrated in FIGS. 2 and 3. This case 11 includes, in the inside, a supply roll 12 on which an unused symbol tape 1a is wound, and a collection roll 13 for collecting a used base tape 1b. Also, on the outside of the case 11, a head 14 for transferring the symbol tape 1 onto the memorandum sheet (DOC) is provided. The base tape 1b is adhered to the front surface side of the unused symbol tape 1a according to the first embodiment, via an adhesive layer formed on the back surface side of the base tape 1b. The adhesive force of the adhesive layer of the base tape 1b is weaker than the adhesive force of the adhesive layer on the back surface of the symbol tape 1. Accordingly, by moving the case 11 in parallel to the surface of the memorandum sheet (DOC) while pressing the head 14 against the memorandum sheet (DOC), the symbol tape 1 is transferred onto the memorandum sheet (DOC). At this time, the base tape 1b adhered to the front surface of the symbol tape 1 is separated, and is wound around the collection roll 13.

Additionally, the symbol tape 1 according to the first embodiment has its entire front surface colored, but the symbol tape 1 may have a part of its front surface colored by having a line or a specific pattern formed on the front surface; specifically, the symbol tape 1 may have a part of itself function as the symbol M1. Also, to increase the convenience, the symbol tape 1 according to the first embodiment is accommodated inside the case 11, and is wound around the supply roll 12, but it does not have to be accommodated inside the case 11. Also, it does not have to be wound around the supply roll 12 or the like. For example, the symbol tape 1 may have a rectangular shape. In this case, a cover tape for covering the adhesive layer on the back surface is desirably stuck to the back surface of the symbol tape 1.

<<Smartphone>>

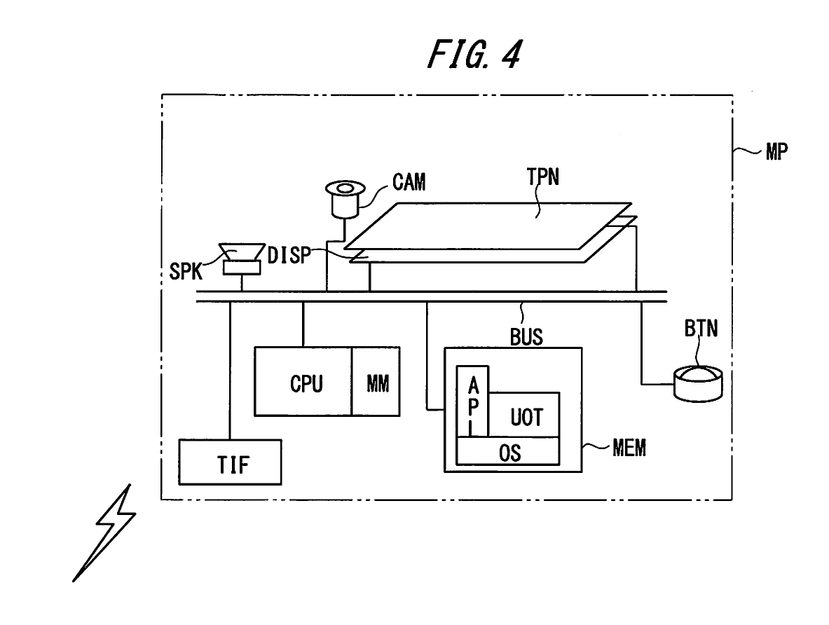

FIG. 4 illustrates a configuration diagram of a smartphone with a camera (hereinafter referred to simply as a smartphone) according to the first embodiment. The smartphone (MP) is an iPhone (a registered trademark) of Apple Inc., or an Android mobile phone (Android: a registered trademark), for example.

With the smartphone (MP), a memorandum sheet (DOC) on which the symbol tape 1 is attached is imaged by the camera (CAM), and the symbol M1 is detected from the original image of the imaging object imaged by the camera (CAM). An image acquisition area (AR: an area surrounded by the symbol M1) is recognized based on the detected symbol M1, and an image in the image acquisition area (AR) (for example, the text “ABCDEF” in FIG. 1) is extracted and saved (stored) in a memory as image data.

A home button (BTN) is provided to the main body of the smartphone (MP) to cause icons and menus displayed on a display (DISP) to return to a home screen or to function as a shutter of the camera (CAM).

Inside the smartphone (MP), there are provided, around a central processing unit (CPU), a main memory (MM), and a memory unit (MEM), a communication interface (TIF), the camera (CAM), the above-described button (BTN), a touch panel display in which a touch panel (TPN) and the display (DISP) are integrated, and a speaker (SPK) that are connected by a bus (BUS).

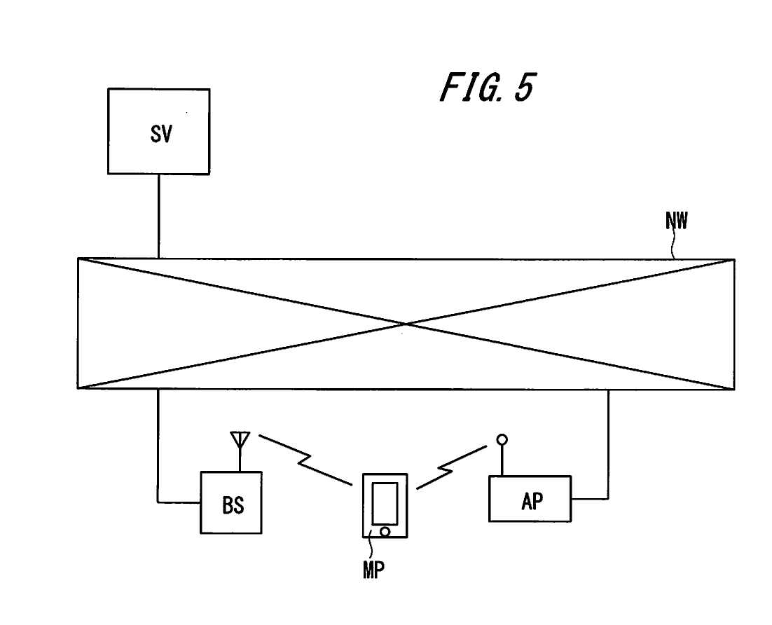

As illustrated in FIG. 5, the communication interface (TIF) may connect to a general-purpose network (NW) through a wireless telephone line and via a base station (BS). Also, this communication interface (TIF) is capable of communication with an access point (AP) of a wireless LAN, and of connecting to the network via either of the communication means.

In the memory unit (MEM), a user data area (UDT) for holding an image processing application program (APL), original image data, and text information is provided together with an operating system (OS).

Capturing and image processing of a memorandum sheet (DOC) to which the symbol tape 1 is attached are performed by the central processing unit (CPU) reading, via the bus (BUS) and the main memory (MM), and executing the image processing application program (APL) in the memory unit (MEM).

<<Image Processing>>

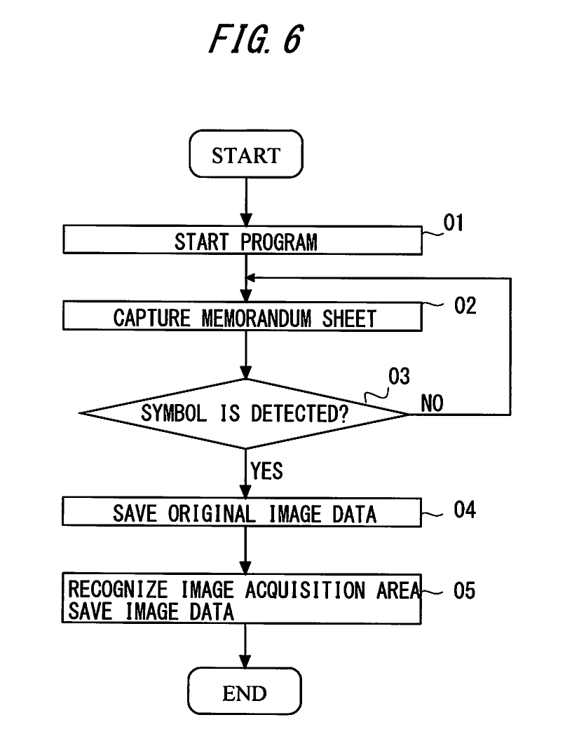

Next, image processing that is performed by the image processing system according to the first embodiment will be described. FIG. 6 illustrates an image flow. In preparation for image processing, the symbol tape 1 is attached in such a way as to surround the area desired by the user to be saved as image data, among letters, signs and the like on the memorandum sheet (DOC).

In step 01, when the present image processing application program (APL) is selected by a touch operation by the user on the touch panel (TPN), the central processing unit (CPU) starts the image processing application program (APL). The function of the camera (CAM) is thereby placed in an operation state, and capturing of the memorandum sheet (DOC) which is an imaging object is enabled. When the image processing application program (APL) is started, step 02 is performed.

In step 02, the memorandum sheet (DOC) is imaged by the operation by the user, and the central processing unit (CPU) temporarily saves (stores) the imaged image in a predetermined area of the memory unit (MEM) as original image data. When the memorandum sheet is imaged, step 03 is performed.

In step 03, the central processing unit (CPU) detects a symbol M1 from the original image data. Detection of the symbol M1 is performed by, for example, setting in advance, and saving (storing) in the memory unit (MEM), the conditions of the symbol M1, and comparing the base color of the memorandum sheet (DOC), the line, the sign, or the letter drawn on the memorandum sheet (DOC) or the like included in the original image data with the set conditions. In the case where the symbol M1 is the symbol tape 1, as in the first embodiment, the set conditions may be “base color of memorandum sheet: white, type of symbol: symbol tape, color/wavelength: red, mode: straight line, width: ◯◯ mm”, for example. If the symbol M1 is detected, step 04 is performed. On the other hand, if the symbol M1 is not detected, the process returns to step 02, and the memorandum sheet (DOC) is imaged again.

In step 04, the central processing unit (CPU) saves the original image data at the time of detection of the symbol M1 in the memory unit (MEM). At the time of saving the original image data, the central processing unit (CPU) may output a shutter sound from the speaker (SPK) to notify of determination of acceptance of the original image data. Additionally, also in the case where the symbol M1 is not detected in step 03, a shutter sound may be generated at the time of temporarily saving the original image in step 02. When the original image data is saved, step 05 is performed.

In step 05, the central processing unit (CPU) recognizes the part surrounded by the detected symbol M1 as an image acquisition area (AR), and extracts an image in the image acquisition area (AR) and saves the same in the memory unit (MEM) as image data. Additionally, if a part of the symbol is lacking, the symbol for the lacking part may be extended to set a virtual line, and the part surrounded by the virtual line and the symbol may be recognized as the image acquisition area (AR). The image processing is thereby ended.

Additionally, the central processing unit (CPU) may perform keystone correction. The keystone correction may be performed according to the set conditions. In the case of performing the keystone correction, the central processing unit (CPU) recognizes the edges of the memorandum sheet (DOC), and corrects (keystone correction) the edges that are trapezoidal due to capturing being performed from an oblique direction to achieve a rectangle, for example. An existing technique may be used as appropriate for the keystone correction.

Now, in the description given above, a case where all the processes are performed by the smartphone (MP) is described, but a part of the processes may be performed by a server (SV) connected via the network (NW).

For example, after capturing the memorandum sheet (DOC) by the camera (CAM), the original image data is temporarily saved in the memory unit (MEM), and also, is transmitted to the server (SV) via the communication interface (TIF) and the network (NW).

Based on the image processing application program (APL) stored in the server (SV), the server which has received the original image data may detect the symbol M1 from the original image data, recognize the part surrounded by the detected symbol M1 as the image acquisition area (AR), and extract the image in the image acquisition area (AR) and save the same in the server (SV) as image data.

The image data saved in the server (SV) may be accessed by the smartphone (MP) via the network (NW).

<<Effect>>

With the image processing system according to the first embodiment, the symbol tape 1 configuring the symbol M1 is attached to the memorandum sheet (DOC) as an imaging object and the memorandum sheet (DOC) to which the symbol M1 is attached is imaged to thereby allow recognition of the area surrounded by the symbol M1 as the image acquisition area (AR) and saving of the recognized image acquisition area (AR) as image data. Accordingly, acquisition/storing of image data drawn in an arbitrary area by a user may be easily performed without the use of a dedicated document sheet to which a symbol is attached in advance. Furthermore, although the symbol tape 1 is attached to the memorandum sheet (DOC), this symbol tape 1 may be removed from the memorandum sheet (DOC) after capturing. Since the symbol does not have to be attached in advance to the memorandum sheet (DOC) itself, and the symbol may be removed after capturing, the design of an imaging object may be improved.

### Second Embodiment

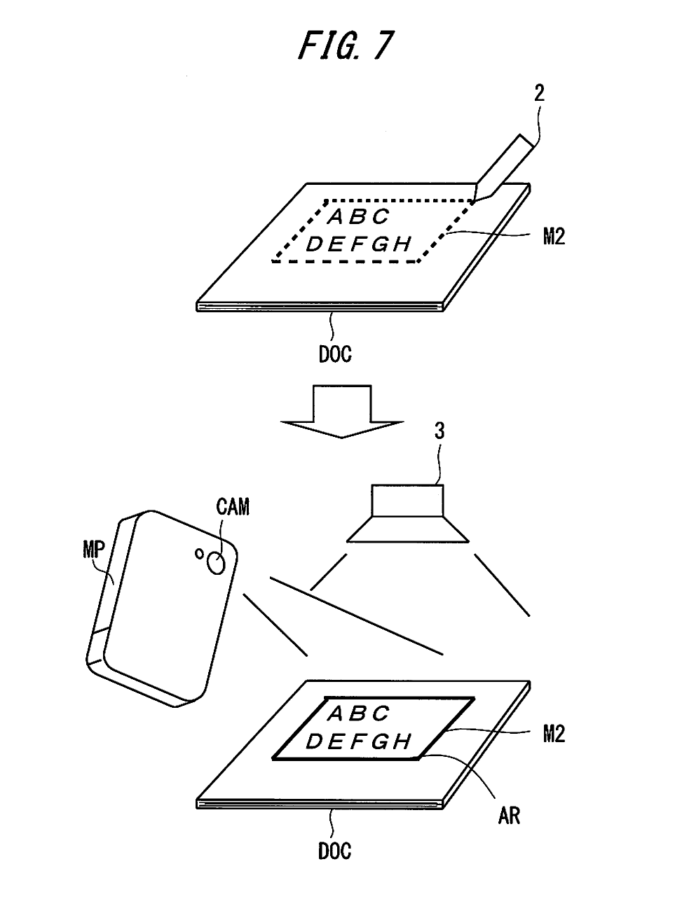

FIG. 7 illustrates a diagram describing an image processing system according to a second embodiment. The image processing system according to the second embodiment includes a smartphone (MP), a writing tool 2 for attaching a symbol to a memorandum sheet (DOC), and a light source 3 for radiating light of a specific wavelength. Additionally, the smartphone (MP) is basically the same as the smartphone (MP) described in the first embodiment. Descriptions about configurations the same as those of the first embodiment, including the smartphone (MP), are omitted, and differences will be mainly described.

<<Writing Tool>>

The writing tool 2 is a pen-type tool, and is filled with ink, and by causing the tip of the pen to come into contact with a memorandum sheet (DOC), lines, letters, signs, figures and the like as a symbol may be freely drawn on the memorandum sheet (DOC). Also, the writing tool 2 according to the second embodiment may draw a symbol having an optical pattern which is not perceived by human eyes under normal visible light. For example, as the ink, one that includes a fluorescent material that emits light when irradiated with black light (ultraviolet light) is cited as an example. Visible light is electromagnetic radiation of about 380 to 800 nm, and black light is electromagnetic radiation of about 350 to 380 nm, and can hardly be perceived by human eyes. Moreover, in addition to the one mentioned above, the ink may be an infrared reflective paint that reflects light of a specific wavelength (infrared light) that is irradiated thereon. Also, a filter for changing the wavelength of light may be used together with the writing tool 2. As the filter for changing the wavelength of light, a visible light cut filter is cited as an example. Additionally, the ink may be an existing so-called invisible ink. As the invisible ink, an ink that becomes visible when heated, an ink that becomes visible when coming into contact with acid or base, and an ink that changes color when irradiated with light are cited as examples.

<<Light Source>>

The light source 3 is for radiating light of a specific wavelength, and for example, black light may be used. As described above, the black light is electromagnetic radiation of about 350 to 380 nm. In the second embodiment, the light source 3 is a separate configuration from the smartphone (MP), but it may alternatively be embedded in the smartphone (MP). Additionally, in the case of using an ink that becomes visible when heated, a heater may be used instead of the light source 3. Also, in the case of using an ink that becomes visible when coming into contact with acid or base, an ink that includes a chemical substance that causes chemical reaction for becoming visible may be used instead of the light source 3.

<<Image Processing>>

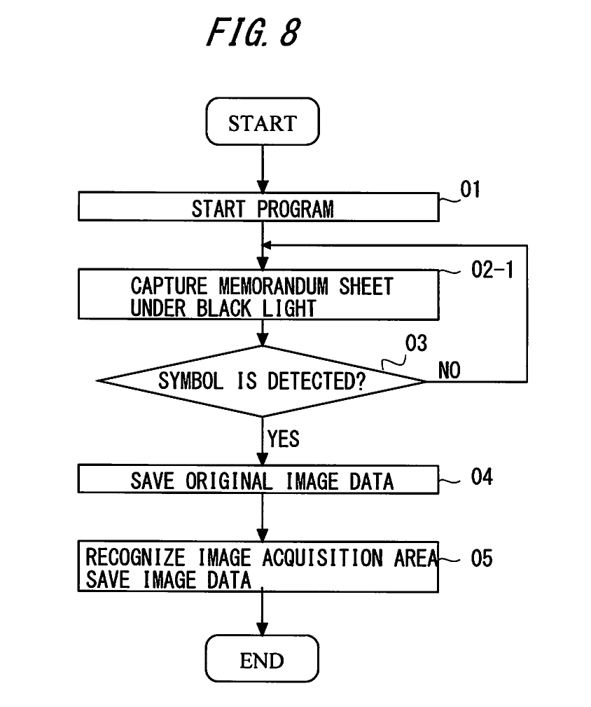

FIG. 8 illustrates a flow of image processing that is performed by the image processing system according to the second embodiment. Image processing that is performed by the image processing system according to the second embodiment is basically the same as the image processing that is performed by the image processing system according to the first embodiment described above. In the following, differences will be mainly described. First, in preparation for image processing, a symbol M2 is drawn by the writing tool 2 so as to surround the area desired by the user to be saved as image data, among letters, signs and the like on the memorandum sheet (DOC). At the time of drawing the symbol M2, it is possible to draw the symbol M2 while checking the track by irradiating black light by the light source 3. In the following, as illustrated in FIG. 7, a case where the user has surrounded the area desired to be saved as image data with straight lines will be described as an example.

In step 01, an image processing application program (APL) is started. Next, in step 02-1, a memorandum sheet (DOC) is imaged in a state where black light is irradiated on the memorandum sheet (DOC) by the light source 3. The symbol M2 that is drawn by the writing tool 2 may not be checked under normal visible light, but by irradiating black light by the light source 3, it becomes possible to check the symbol. Also, by performing capturing in this state, an original image including the symbol is temporarily saved.

Next, in step 03, the symbol M2 is detected from the original image. Also in the second embodiment, detection of the symbol M2 may be performed by, for example, setting in advance, and saving in the memory unit (MEM), the conditions of the symbol M2, and comparing the base color of the memorandum sheet (DOC), the line, the sign, or the letter drawn on the memorandum sheet (DOC) or the like included in the original image data with the set conditions. In the case where the symbol is a frame formed from the straight lines drawn by the writing tool 2, as in the second embodiment, the set conditions may be “base color of memorandum sheet (DOC): white, type of symbol: writing tool, color/wavelength: colorless (ultraviolet light is to be irradiated), mode: straight line, width: ◯◯ mm”, for example. If the symbol M2 is detected, step 04 is performed. On the other hand, if the symbol M2 is not detected, the process returns to step 02, and the memorandum sheet (DOC) is imaged again. Additionally, for example, with respect to detection of the symbol M2, capturing may be performed before and after irradiation by black light, and the original images before and after black light irradiation may be compared to obtain the difference and to detect the symbol M2.

In step 04, the original image data at the time of detection of the symbol is saved in the memory unit (MEM). Next, in step 05, the part surrounded by the detected symbol M2 is recognized as an image acquisition area (AR), and the image in the image acquisition area (AR) is extracted and saved in the memory unit (MEM) as image data. Additionally, as in the first embodiment, if a part of the symbol M2 is lacking, the symbol M2 for the lacking part may be extended to set a virtual line, and the part surrounded by the virtual line and the symbol M2 may be recognized as the image acquisition area (AR). Also, keystone correction may be performed as appropriate. The image processing is thereby ended.

<<Other Types of Image Processing>>

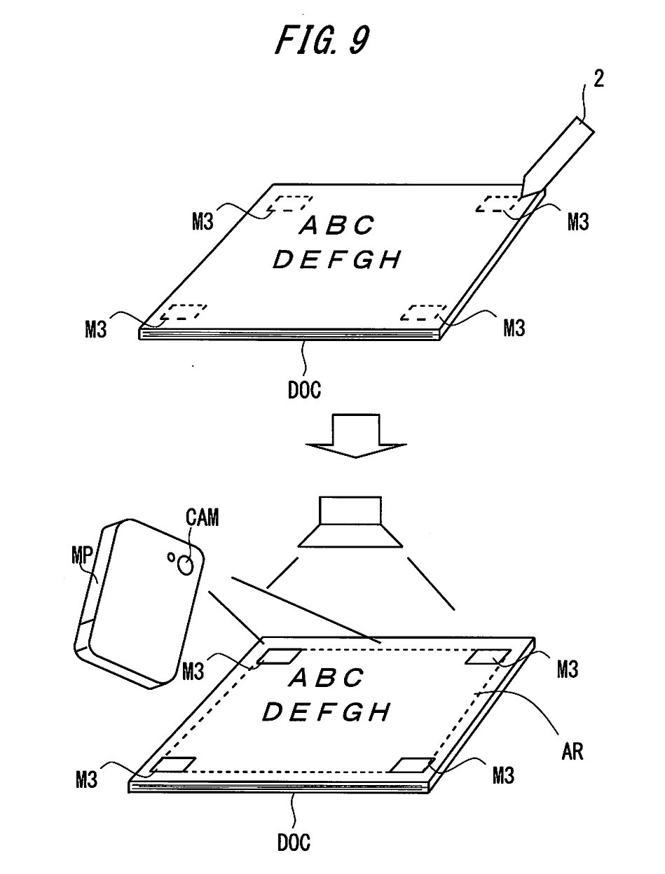

Next, image processing according to an example modification of the second embodiment will be described. In the following, as illustrated in FIG. 9, a case where a plurality of locators M3 are drawn by the writing tool 2 as the symbols, and the central processing unit (CPU) recognizes, as the image acquisition area (AR), the area surrounded by a figure having the detected locators M3 as the vertices will be described. First, in preparation for image processing, the locators M3 as the symbols are drawn by the writing tool 2 at four positions around the area desired by the user to be saved as image data, among letters, signs and the like on the memorandum sheet (DOC). In FIG. 9, frame-like locators M3 are drawn near the four corners of the memorandum sheet. The locators M3 are not limited to be such, and may be of another shape such as a circle, a polygon or the like, or may be letters or signs. Furthermore, these may be combined to be used as the locators M3.

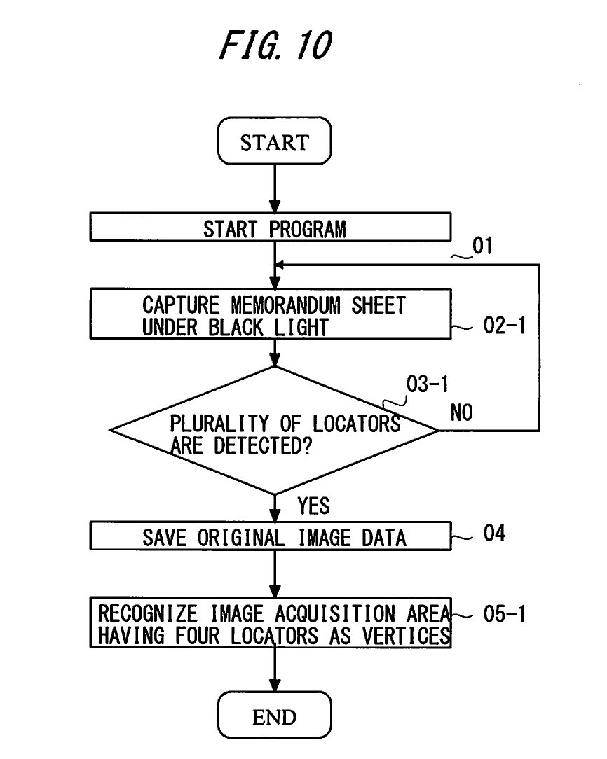

FIG. 10 illustrates a flow of image processing that is performed by the image processing system according to the second embodiment. In step 01, an image processing application program (APL) is started. Then, in step 02-1, a memorandum sheet (DOC) is imaged in a state where black light is irradiated on the memorandum sheet (DOC) by the light source 3, and an original image including a symbol (a locator M3) is temporarily saved.

Next, in step 03-1, a plurality of locators M3 as the symbols are detected from the original image. Also in the example modification of the second embodiment, detection of the symbols (locators M3) may be performed by, for example, setting in advance, and saving in the memory unit (MEM), the conditions of the symbols (locators M3), and comparing the base color of the memorandum sheet (DOC), the line, the sign, or the letter drawn on the memorandum sheet (DOC) or the like included in the original image data with the set conditions. In the case where the symbols are a plurality of locators M3 drawn by the writing tool 2, as in the second embodiment, the set conditions may be “base color of memorandum sheet: white, type of symbol: writing tool, color/wavelength: colorless (ultraviolet light is to be irradiated), mode: locator, shape of locator: frame-shaped, number of locators: four, shape of image acquisition area (AR): square”, for example. If all of the plurality of locators M3 are detected, step 04 is performed. On the other hand, if not all of the plurality of locators M3 are detected, the process returns to step 02-1, and the memorandum sheet (DOC) is imaged again.

Additionally, if the shape of the image acquisition area (AR) is square according to the set conditions, if two locators M3 at diagonal corners are detected, the positions of other locators M3 may be estimated even if just two locators M3 are detected. Accordingly, the conditions for detection may be changed depending on the set conditions. Also, for example, with respect to detection of the plurality of locators M3, capturing may be performed before and after irradiation by black light, and the original images before and after black light irradiation may be compared to obtain the difference and to detect the plurality of locators.

In step 04, the original image data at the time of detection of the symbols is saved in the memory unit (MEM). Next, in step 05-1, the central processing unit (CPU) recognizes the square area having the four locators M3 which have been detected as the vertices as the image acquisition area (AR), and extracts an image in the image acquisition area (AR) and saves the same in the memory unit (MEM) as image data. The vertex of each locator M3 may be the center of the locator M3, or may be a part of the outer part of the locator M3 (for example, in the present example modification, the corner portion of the frame). Additionally, keystone correction may be performed as appropriately. The image processing is thereby ended.

Additionally, in the example modification, the four locators M3 have the same shape, but the shape of one of the four locators M3 may be different from that of the other locators M3, for example. In this case, the locator having a different shape may be caused to function as a symbol for specifying the direction of the image acquisition area.

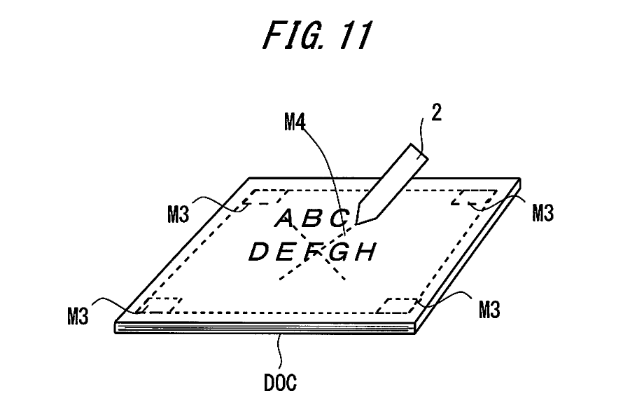

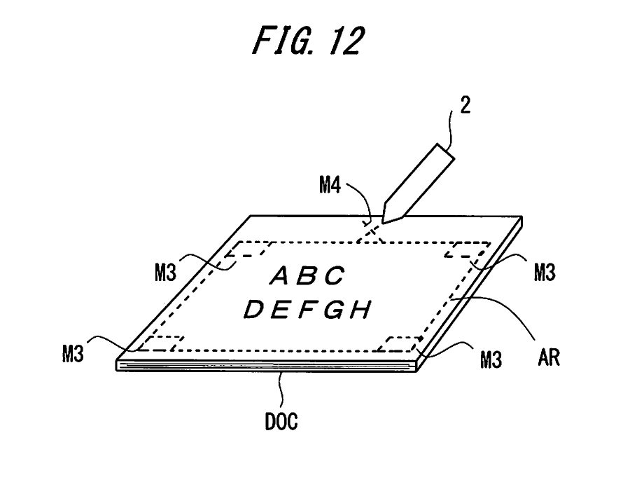

Also, in addition to the locators M3 for specifying the image acquisition area (AR), a locator having another shape (for example, an X mark) may be separately provided. The locator having another shape may be caused to function as a symbol for specifying the direction of the image acquisition area (AR). Also, the locator having another shape may be caused to function as a symbol for cancelling the specified image acquisition area (AR). Set conditions for the locator having another shape and its function may be set in advance. For example, as illustrated in FIG. 11, in the case where a locator M4 having another shape is present within the specified image acquisition area (AR), the central processing unit (CPU) cancels the specified image acquisition area (AR). Also, for example, as illustrated in FIG. 12, in the case where a locator M5 having another shape is present outside the specified image acquisition area (AR), the central processing unit (CPU) specifies the side where the locator M5 having another shape is present as the upper side of the specified image acquisition area (AR).

<<Effect>>

With the image processing system according to the second embodiment described above, the symbol M2 and the locators M3 drawn by the writing tool 2 with an ink that emits light when irradiated with black light are attached to the memorandum sheet (DOC) as the imaging object. Then, the memorandum sheet (DOC) to which the symbol M2 and the locators M3 are attached is imaged to thereby allow recognition of the area surrounded by the symbol M2 and the locators M3 as the image acquisition area (AR) and saving of the recognized image acquisition area (AR) as image data. Accordingly, acquisition/storing of image data drawn in an arbitrary area by a user may be easily performed without the use of a dedicated document sheet to which a symbol is attached in advance. Furthermore, since the symbol M2 and the locators M3 drawn by the writing tool 2 are not perceived under normal visible light, the design of the memorandum sheet (DOC) is improved.

Also, by providing locators M4 and M5 having shapes that are different from that of the symbol (locator) for specifying the image acquisition area (AR), and by providing these locators M4 and M5 having different shapes with functions of determining the direction of the specified image acquisition area (AR) and of cancelling the specified image acquisition area (AR), the convenience is further increased.

### Other Embodiments

In the description given above, the symbol sheet 1 is directly attached to the memorandum sheet (DOC), or the symbol M2 and the locator M3 are drawn by the writing tool 2 directly on the memorandum sheet (DOC), but the symbol sheet 1 may be attached to a transparent plastic sheet, or the symbol M2 and the locator M3 may be drawn by the writing tool 2 directly on the transparent plastic sheet. Then, the plastic sheet to which the symbol is attached may be placed on the memorandum sheet (DOC), and the surface of the memorandum sheet (DOC) may be imaged by the camera (CAM) through the plastic sheet.

Also, in the description given above, the imaging object is described to be the memorandum sheet (DOC), but it may be a sheet of writing paper about the size A4, a sheet of blank paper, a printed document, a business card, a memorandum sheet the size of a business card, or the like.

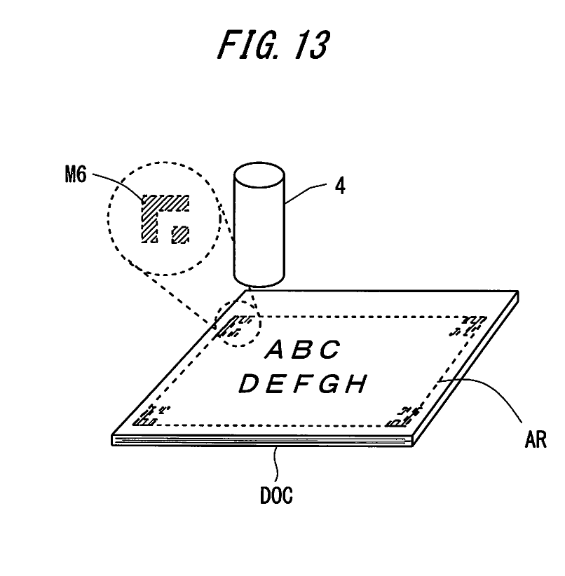

Moreover, the writing tool 2 has been described as an example of the assistant tool, but as illustrated in FIG. 13, the assistant tool may be a stamp 4 on which a specific locator is engraved in advance and which is filled with ink. As the ink, one that includes a fluorescent material that emits light when irradiated with black light (ultraviolet light) may be used. In the case of the writing tool 2, although the degree of freedom is high, the shape of the symbol to be drawn is varied depending on the user, and detection may become difficult. In contrast, with the stamp on which a specific locator is engraved in advance, detection of the locator is easy. A locator M6 illustrated in FIG. 13 includes appearing portions of a color value different from the base color of the memorandum sheet (DOC), and a non-appearing portion of the base color of the memorandum sheet (DOC), and includes at least an appearing portion including straight lines and a corner, i.e. two straight lines and a corner where the ends of the two straight lines meet, and a rectangular appearing portion positioned on the inside the appearing portion including the straight lines and the corner, where the non-appearing is formed from the area between the appearing portion including the straight lines and the corner and the rectangular appearing portion. Additionally, such a locator M6 is merely an example, and locators of other shapes may also be used.

Additionally, the various contents described above may be combined in any manner within the technical idea of the present invention.

1. A mobile terminal comprising:
a camera that images an imaging object to which a symbol sheet including a predetermined symbol is attached;
a central processing unit that detects the predetermined symbol from an original image of the imaging object imaged by the camera, that recognizes a predetermined area calculated based on the predetermined symbol as an image acquisition area, and that extracts, and acquires as image data, an image in the image acquisition area; and
image data storage unit that stores the image data.

2. The mobile terminal according to claim 1, wherein the predetermined symbol is formed from an optical pattern that is different from an optical pattern present within a predetermined area of the imaging object.

3. A mobile terminal comprising:
a camera that images an imaging object to which a predetermined symbol is attached by a user;
a central processing unit that detects the predetermined symbol from an original image of the imaging object imaged by the camera, that recognizes a predetermined area calculated based on the predetermined symbol as an image acquisition area, and that extracts, and acquires as image data, an image in the image acquisition area; and
image data storage unit that stores the image data,
wherein the predetermined symbol is an optical pattern that is not perceived by a human eye under normal visible light.

4. The mobile terminal according to claim 1, wherein the predetermined symbol is an optical pattern that emits light that can be perceived by the camera when irradiated with light of a specific wavelength.

5. The mobile terminal according to claim 1, wherein the central processing unit detects the predetermined symbol from the original image, and recognizes an area, of the imaging object, surrounded by the predetermined symbol as the image acquisition area.

6. The mobile terminal according to claim 1,
wherein the predetermined symbol is formed from a line image, and
wherein the central processing unit recognizes an area surrounded by the line image as the image acquisition area.

7. The mobile terminal according to claim 1,
wherein the predetermined symbol is a locator formed from a dot or a specific figure, and
wherein, when a plurality of the locators attached to the imaging object are detected, the central processing unit recognizes an area surrounded by a figure having the detected locators as vertices as the image acquisition area.

8. A symbol sheet to be used together with a mobile terminal including a camera that images an imaging object to which a predetermined symbol is attached, a central processing unit that detects the predetermined symbol from an original image of the imaging object imaged by the camera, that recognizes a predetermined area calculated based on the predetermined symbol as an image acquisition area, and that extracts, and acquires as image data, an image in the image acquisition area, and image data storage unit that stores the image data,
wherein the symbol sheet is to be attached to the imaging object, and includes the predetermined symbol at least on a side of a surface to be imaged.

9. An assistant tool to be used together with a mobile terminal including a camera that images an imaging object to which a predetermined symbol is attached, a central processing unit that detects the predetermined symbol from an original image of the imaging object imaged by the camera, that recognizes a predetermined area calculated based on the predetermined symbol as an image acquisition area, and that extracts, and acquires as image data, an image in the image acquisition area, and image data storage unit that stores the image data,
wherein the assistant tool includes an ink for attaching the predetermined symbol to the imaging object, and
wherein, when attached to the imaging object by a user, the ink becomes an optical pattern that is not perceived by a human under normal visible light.

10. The assistant tool according to claim 9, wherein the ink includes at least one of an inorganic fluorescent paint and an infrared reflective paint.

11. An image processing program that is executable by a mobile terminal including a central processing unit that, when an imaging object to which a symbol sheet including a predetermined symbol is attached is imaged by a camera, detects the predetermined symbol from an original image of the imaging object imaged by the camera, recognizes a predetermined area calculated based on the predetermined symbol as an image acquisition area, and extracts, and acquires as image data, an image in the image acquisition area, and image data storage unit that stores the image data, the image processing program causing the central processing unit to execute:
when the imaging object is imaged by the camera in such a way that a position of the predetermined symbol is included,
detecting the predetermined symbol from the original image, recognizing a predetermined area calculated based on the position of the detected predetermined symbol as an image acquisition area, and extracting, and acquiring as image data, the image in the image acquisition area; and
storing the image data in the image data storage unit.

12. An image processing method that is executable by a mobile terminal including a central processing unit that, when an imaging object to which a symbol sheet including a predetermined symbol is attached is imaged by a camera, detects the predetermined symbol from an original image of the imaging object imaged by the camera, recognizes a predetermined area calculated based on the predetermined symbol as an image acquisition area, and extracts, and acquires as image data, an image in the image acquisition area, and image data storage unit that stores the image data, the image processing method causing the central processing unit to execute:
when the imaging object is imaged by the camera in such a way that a position of the predetermined symbol is included,
detecting the predetermined symbol from the original image, recognizing a predetermined area calculated based on the position of the detected predetermined symbol as an image acquisition area, and extracting, and acquiring as image data, the image in the image acquisition area; and
storing the image data in the image data storage unit.

13. An image processing program that is executable by a mobile terminal including a camera that images an imaging object to which a predetermined symbol is attached by a user, a central processing unit that detects the predetermined symbol from an original image of the imaging object imaged by the camera, that recognizes a predetermined area calculated based on the predetermined symbol as an image acquisition area, and that extracts, and acquires as image data, an image in the image acquisition area, and image data storage unit that stores the image data, the image processing program causing the central processing unit to execute:
when the imaging object is imaged by the camera in such a way that a position of the predetermined symbol is included,
detecting, from the original image, the predetermined symbol that is an optical pattern that is not perceived by a human eye under normal visible light, recognizing a predetermined area calculated based on the position of the detected predetermined symbol as an image acquisition area, and extracting, and acquiring as image data, the image in the image acquisition area; and
storing the image data in the image data storage unit.

14. An image processing method that is executable by a mobile terminal including a camera that images an imaging object to which a predetermined symbol is attached by a user, a central processing unit that detects the predetermined symbol from an original image of the imaging object imaged by the camera, that recognizes a predetermined area calculated based on the predetermined symbol as an image acquisition area, and that extracts, and acquires as image data, an image in the image acquisition area, and image data storage unit that stores the image data, the image processing method causing the central processing unit to execute:
when the imaging object is imaged by the camera in such a way that a position of the predetermined symbol is included,
detecting, from the original image, the predetermined symbol that is an optical pattern that is not perceived by a human eye under normal visible light, recognizing a predetermined area calculated based on the position of the detected predetermined symbol as an image acquisition area, and extracting, and acquiring as image data, the image in the image acquisition area; and
storing the image data in the image data storage unit.

14. The mobile terminal according to claim 3, wherein the predetermined symbol is an optical pattern that emits light that can be perceived by the camera when irradiated with light of a specific wavelength.

15. The mobile terminal according to claim 3, wherein the central processing unit detects the predetermined symbol from the original image, and recognizes an area, of the imaging object, surrounded by the predetermined symbol as the image acquisition area.

16. The mobile terminal according to claim 3,
wherein the predetermined symbol is formed from a line image, and
wherein the central processing unit recognizes an area surrounded by the line image as the image acquisition area.

17. The mobile terminal according to claim 3,
wherein the predetermined symbol is a locator formed from a dot or a specific figure, and
wherein, when a plurality of the locators attached to the imaging object are detected, the central processing unit recognizes an area surrounded by a figure having the detected locators as vertices as the image acquisition area.
